(19) United States
(12) Patent Application Publication
(10) Pub. No.: US 2009/0300583 A1
(43) Pub. Date: Dec. 3, 2009

(54) Apparatus, Method, and Computer Program Product for Performing a Software Build

(75) Inventors: Peter Joseph Cork, Tampere (FI); Tomi Tapio Korhonen, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/129,879

(22) Filed: May 30, 2008

(51) Int. Cl. G06F 9/44

(52) U.S. Cl. 717/120

(57) ABSTRACT

In accordance with an example embodiment of the present invention, an apparatus, comprising at least one receiver configured to receive a first software build information and at least one transmitter configured to send a computer program, wherein the computer program is based at least in part on the first software build information and a second software build information, is disclosed.

### TECHNICAL FIELD

The present application relates generally to software building.

### BACKGROUND

Computer programs are becoming an increasingly important part of many electronic products. Many electronic products comprise at least one computer program. To generate a computer program, a software component may have a software build process performed on it. A software build process may comprise compiling, linking, assembling, and/or the like. A software build process may comprise the usage of build information related to a software component. The build information may comprise source code, object code, header information, configuration information, build information, data information, and/or the like. In some cases, a software build process may comprise the usage of build information related to more than one software component. The output of a software build process may comprise at least part of a computer program. For example, the output of a software build process may comprise a ROM image, a dynamically linked library (DLL), an executable program, such as a word processor, a resource file, and/or the like.

In some cases, software components may be developed by more than one entity. For example, one software component may be developed by a device manufacturer, and another software component is developed by a user of the device. In another example, different components may be developed by different companies.

### SUMMARY

Various aspects of the invention are set out in the claims.

In accordance with an example embodiment of the present invention, an apparatus, comprising at least one receiver configured to receive a first software build information and at least one transmitter configured to send a computer program, wherein the computer program is based at least in part on the first software build information and a second software build information, is disclosed.

In accordance with another example embodiment of the present invention, a method, comprising receiving a first software build information and sending a computer program, wherein the computer program is based at least in part on the first software build information and a second software build information, is disclosed.

In accordance with another example embodiment of the present invention, A computer program product comprising a computer-readable medium bearing computer program code embodied therein for use with a computer, the computer program code comprising code for receiving a first software build information and code for sending a computer program, wherein the computer program is based at least in part on the first software build information and a second software build information, is disclosed.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram of an example embodiment of software components related to a software build process;

FIG. 2 is a block diagram of an example embodiment of a software building apparatus;

FIG. 3 is a flow diagram of an example embodiment of a software building method;

FIG. 4 is a diagram of another example embodiment of a software building apparatus;

FIG. 5 is a diagram of illustrating a method for building software according to an example embodiment;

FIG. 6 is a diagram of yet another example embodiment of a software building apparatus; and

FIG. 7 is a diagram of an example embodiment of a communicating apparatus.

### DETAILED DESCRIPTION OF THE DRAWINGS

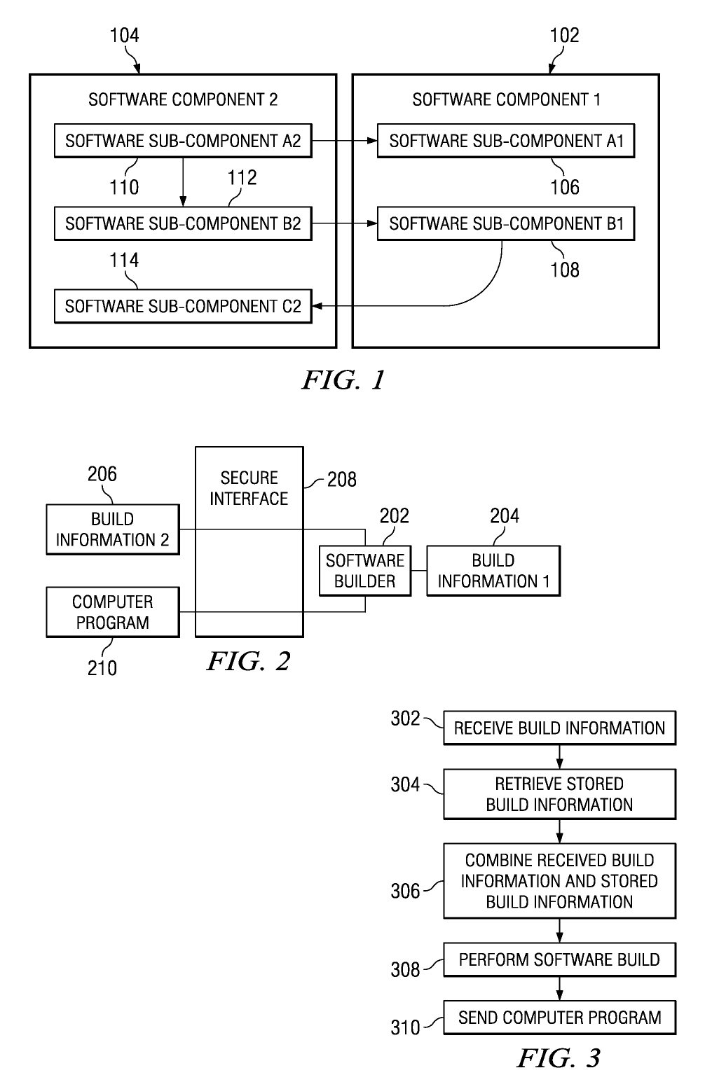

An example embodiment of the present invention and its potential advantages are best understood by referring to FIGS. 1 through 7 of the drawings.

A software build process, as related to embodiments of the present invention, may comprise compiling, linking, assembling, and/or the like. It should be understood, however, that the software build process described hereinafter merely refers to an example embodiment of a software build process and may relate to any software build process currently known or created in the future, and therefore, should not be taken to limit the scope of the present invention.

Software build information, as related to embodiments of the present invention, may comprise source code, object code, header information, configuration information, build information, data information, file version information, location of software components in a computer program, symbol information, mapping information, library information, binary information, and/or the like. It should be understood, however, that the software build information related to hereinafter merely refers to an example embodiment of a software build information and may relate to any software build information currently known or created in the future, and therefore, should not be taken to limit the scope of the present invention.

It may be desirable to utilize information related to one software component developed by one entity when performing a software build process on another software component developed by another entity. For example, when performing a software build process of a software component that may utilize an operating system, it may be desirable to utilize information related to the operating system. In such an example, the software component may utilize a data structure, a class, a function, and/or the like related to the operating system. In this example, it may be desirable to utilize information related to the data structure, the class, the function, and/or the like in the build process to generate at least part of a computer program.

FIG. 1 is a block diagram of an example embodiment of software components related to a software build process. It should be understood, however, that the software component embodiment of FIG. 1 as illustrated and hereinafter described is merely illustrative of a software component embodiment which may benefit from the present invention, and therefore, should not be taken to limit the scope of the present invention.

A relationship between software components related to a software build process according to an example embodiment is described hereinafter. In an example embodiment, software component 1 (102) may comprise a software sub-component A1 (106) and a software sub-component B1 (108). In an example embodiment, software component 2 (104) may comprise software sub-component A2 (110), software sub-component B2 (112), and software sub-component C2 (114). It should be understood that the terminology of software component and software sub-component is used merely to denote the relationship of the different parts and should not serve to limit the scope of the present invention. A software component and/or software sub-component may comprise a software application, a library, an object file, a source code file, a header file, a resource file, and/or the like. In the example embodiment of FIG. 1, there may be software build dependencies between software sub-component A2 (110) and software sub-component A1 (106), between software sub-component A2 (110) and software sub-component B2 (112), between software sub-component B2 (112) and software sub-component B1 (108), and between software sub-component B1 (108) and software sub-component C2 (112). For example, software component A1 may utilize a part of software component A2, for example a data structure. In such an example, at least part of the software build of software component A2 may be based at least in part on software component A1.

It may be desirable to build software components and/or sub-components in relation to their dependencies. For example, it may be desirable to build a software component after building another software component on which it depends. In the illustrated embodiment, it may be desirable to build software sub-component C2 (114) before building software component B1 (108). In the same example, it may be further desirable to build software sub-component B2 (112) after building software sub-component B1 (108). In this example, it can be seen that it may be desirable to build a software sub-component of one software component between building two software sub-components of another software component. It should be understood that there may be dependencies among more than two software components and/or subcomponents. It should be further understood that there may be varying levels of hierarchy among software being built.

In some cases, a computer program may comprise software components from various companies. For example, some mobile phone products comprise a software component developed by Symbian LTD, a software component developed by Nokia Oyj, a software component developed by Texas Instruments Inc, and software components developed by other companies or individuals. One software component from one company may utilize another software component from another company. For example, a software component from an operating system provider may utilize a device driver from a hardware vendor.

In some cases, it may be desirable to keep some information relating to a software component confidential. For example, it may be desirable for information related to authentication, encryption, decryption, security, proprietary design element, trade secret, information under an agreement to not disclose and/or the like to be kept confidential. It may also be desirable to allow usage of confidential information for a software build process without disclosing the confidential information. For example, if a software component controlled by a company is confidential, it may be desirable to maintain the confidentiality of the software component while allowing a developer outside of the company to build software which may have a dependency relationship with the confidential information.

In an example embodiment, an apparatus provider may desire to allow software developers to produce software for their apparatus while maintaining confidentiality of at least part of the software components which may be utilized by the software developers. For example, a company making digital video recorders may desire to allow software developers to generate computer programs for the digital video recorder. In this example, it may be desirable to provide software developers with the ability to utilize a software component, such as a video decryption component, while restricting access to confidential information the software component may comprise.

FIG. 2 is a block diagram of an example embodiment of a software building apparatus. It should be understood, however, that the embodiment of FIG. 2 as illustrated and hereinafter described is merely illustrative of a software building apparatus, and therefore, should not be taken to limit the scope of the present invention.

Block 202 of FIG. 2 represents a software builder. The software builder (202) may comprise a communicating apparatus, for example communicating apparatus (700) of FIG. 7. The software builder (202) may comprise a processor, memory, compiler, assembler, linker, and/or the like. The software builder (202) may perform a software build process. The software builder (202) may output a computer program (210) based at least in part on build information 1 (204) and build information 2 (206). The computer program (210) may comprise executable code, object code, encrypted executable code, and/or the like. The build information may comprise build content, such as source code information, header information, and/or the like. The build information may comprise at least one build directive, such as a makefile, a build command, and/or the like. It should be understood that build information 1 (204) may comprise build information related to at least part of at least one software component. It should be understood that build information 2 (206) may comprise build information related to at least part of at least one software component.

Block 208 represents a secure interface for receiving build information 2 (206) and sending computer program (210). The secure interface may comprise a communicating apparatus, for example communicating apparatus (700) of FIG. 7. The confidentiality of build information 1 (204) may be protected by the secure interface (208). For example, the secure interface (208) may receive build information 2 (206) and send the computer program (210) while at least partially limiting access to build information 1 (204). For example, if build information 1 (204) comprises confidential build information, such as an encryption algorithm, the secure interface (208) may receive the build information 2 (206) and send the computer program (210) while retaining the confidentiality of build information 1 (204). The secure interface (208) may utilize messaging, method invocation, shared storage, and/or the like.

FIG. 3 is a flow diagram of an example embodiment of a software building method. It should be understood, however, that the software building method of FIG. 3 as illustrated and hereinafter described is merely illustrative of an embodiment of a software building method, and therefore, should not be taken to limit the scope of the present invention.

At block 302 of FIG. 3 build information, for example build information 2 (206) of FIG. 2, is received. The build information may be received by a secure interface, for example, secure interface (208) of FIG. 2. Receiving the build information may comprise utilization of a message, a command, a file transfer, and/or the like. It should be understood that build information may comprise build information related to at least part of at least one software component. At block 304, stored build information, for example build information 1 (204) of FIG. 2, is retrieved. In an example embodiment, the stored build information may be retrieved from a local repository and/or a remote repository. For example, part of the stored build information may be retrieved from a hard drive, while another part of the stored build information may be retrieved from a server. The received build information and the stored build information may relate to the same software component, to different software components, and/or any combination thereof. At block 306, at least part of the received build information is combined with the stored build information. The combining may comprise operations related to correlating the received build information to the stored build information. For example, the received build information may be packaged in a compressed file, for example a zip file. In such an example, the combining may comprise unpacking the build information, decompressing the build information, and/or the like so that the stored build information and the received build information are in a similar format. In another example, the combining may comprise merging and/or replacing at least part of stored build information with received build information. In yet another example, the combining may comprise associating at least part of stored build information with received build information. In still another example, combining may comprise associating received build information with at least part of the stored build information. In an example embodiment, a computer program is generated by performing a software build at block 308. At block 310, the computer program is sent. The computer program may be sent by a secure interface, for example, secure interface (208) of FIG. 2. Sending the build information may comprise utilization of a message, a command, a file transfer, and/or the like.

In some cases, it may be desirable to allow a user on a non-secure network to build software. For example, if a software developer is generating software for a mobile device for a mobile service provider, it may be desirable for the mobile service provider to provide a way to allow the software developer to perform software builds using confidential build information from a remote location. In such an example, it may be desirable for the software developer to utilize an internet connection to an apparatus of the mobile service provider to perform the software build. In such an example, due to internet security threats, it may be desirable to utilize a software builder which may reduce the risk of exposing confidential information over the internet.

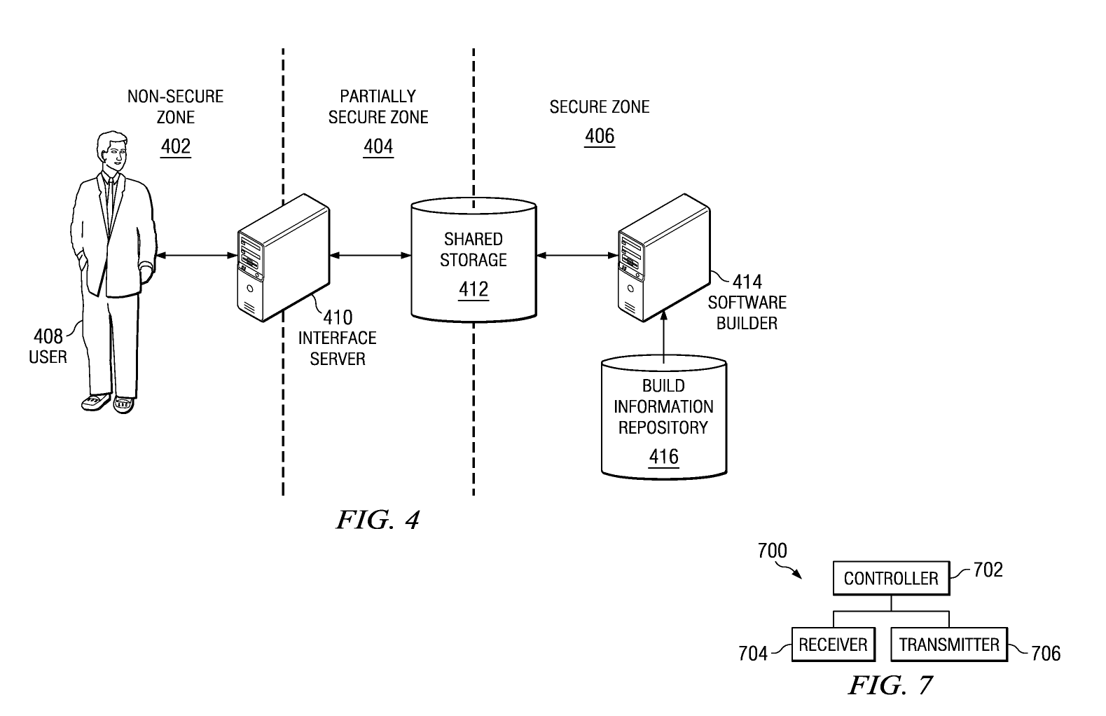

FIG. 4 is a diagram of another example embodiment of a software building apparatus. It should be understood, however, that the software building apparatus of FIG. 4 as illustrated and hereinafter described is merely illustrative of a software building apparatus, and therefore, should not be taken to limit the scope of the present invention.

In an example embodiment, there may be zones relating to a level of security, for example a non-secure zone (402), a partially secure zone (404), a secure zone (406), and/or the like. In an example embodiment, a non-secure zone (402) is a zone where communications may be intercepted, may pass through uncontrolled devices, and/or the like. For example, the internet may be a non-secure zone. In an example embodiment, a partially secure zone (404) is a zone where communication may be difficult to intercept, but where data is accessed by a device that is connected to a non-secure zone. In an example embodiment, a secure zone (406) is a zone where communication may be difficult to intercept and where a device connected to a non-secure zone may not directly access data.

In an example embodiment, a user (408) may operate in a non-secure zone. It should be understood that the user (408) may be a human, a script, a computer program, and/or the like. The user (408) may utilize an interface server (410) in varying ways. For example, the user (406) may utilize a communicating apparatus, for example communicating apparatus (700) of FIG. 7, which communicates with the interface server (410) using an internet connection.

In another example, the user (408) may utilize a kiosk which is connected to an interface server (410). The interface server (410) may provide the user with various operations. For example, the interface server (410) may allow a user to login, choose software build characteristics, send software build information, initiate a software build, receive notification of a completed software build, download a computer program from a completed software build, and/or the like. In an example embodiment, the interface server (410) may utilize a user validation method, such as a user id and/or password, before allowing a user to access at least one of the operations provided by the interface server (410). In an example embodiment, an interface server (410) may utilize a protection mechanism, such as a firewall, to restrict access. The interface server (410) may comprise a communicating apparatus, for example communicating apparatus (700) of FIG. 7. It should be understood that there may be more than one interface server (410). For example, it may be desirable to provide more than one interface server (410) for balancing load, separately managing groups of users, and/or the like.

In an example embodiment, the interface server (410) may be coupled to a shared storage (412). The shared storage may be used to store received build information, for example build information 2 (206) of FIG. 2, a computer program generated by a completed software build, a communication message between the interface server (410) and the software builder (414), and/or the like. The shared storage (412) may comprise a communicating apparatus, for example communicating apparatus (700) of FIG. 7. The shared storage (412) may be remote to or may be local to the interface server (410). The shared storage (412) may be remote to or may be local to the software builder (414).

In an example embodiment, the software builder (414) may be coupled to a build information repository (416). The build information repository (416) may comprise a communicating apparatus, for example communicating apparatus (700) of FIG. 7. The build information repository (416) may comprise stored build information, for example build information 1 (204) of FIG. 2. It should be understood that the build information repository (416) may comprise multiple versions of the same part of the build information. For example, the build information repository (416) may comprise versions 3.1, 3.2, and 4.0 of a source code for the same software component. In an example embodiment the build information repository (416) may comprise confidential build information. For example, the build information repository (416) may comprise source code for an encryption algorithm that a company would like to keep confidential from the user (408), but which may be used by the software builder (414) to perform a software build.

In an example embodiment, the software builder (414) performs a software build. The software builder (414) may comprise a communicating apparatus, for example communicating apparatus (700) of FIG. 7. The software builder (414) may utilize the received build information, for example build information stored in the shared storage (412), and stored build information, for example build information stored in the build information repository (416). The software builder (414) may combine the received build information and the stored build information. The combining may comprise operations related to correlating the received build information to the stored build information. For example, the received build information may be packaged in a compressed file, for example a zip file. In such an example, the combining may comprise unpacking the build information, decompressing the build information, and/or the like so that the stored build information and the received build information are in a similar format. In another example, the combining may comprise merging and/or replacing at least part of stored build information with received build information. In yet another example, the combining may comprise associating at least part of stored build information with received build information. In still another example, combining may comprise associating received build information with at least part of the stored build information. The software builder (414) may perform a software build using the combined build information to generate a computer program. It should be understood that there may be more than one software builder (414).

It may be desirable to have the interface server (410) in a secure zone. For example, if the user (408) is connected to the interfaces server (410) using a virtual private network, the virtual private network may provide the desired level of security. In such an example, the shared storage (412) may be local to the interface server (410). In such an example, the shared storage (412) may be local to the software builder (414).

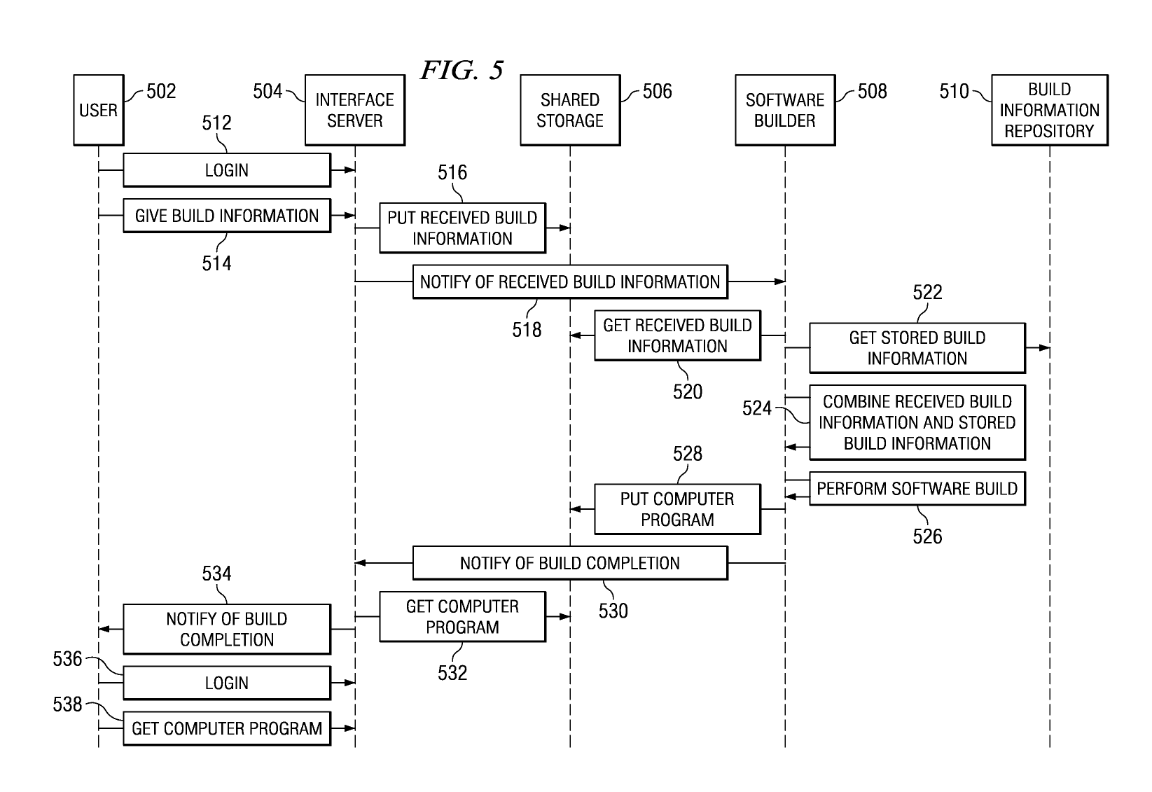

FIG. 5 is a diagram of illustrating a method for building software according to an example embodiment. It should be understood, however, that the software building method of FIG. 5 as illustrated and hereinafter described is merely illustrative of an embodiment of a software building method, and therefore, should not be taken to limit the scope of the present invention.

In an example embodiment, block 502 may relate to a user, for example, user (408) of FIG. 4. In an example embodiment, block 504 may relate to an interface server, for example, interface server (410) of FIG. 4. In an example embodiment, block 506 may relate to a shared storage, for example, shared storage (412) of FIG. 4. In an example embodiment, block 508 may relate to a software builder, for example software builder (414) of FIG. 4. In an example embodiment, block 510 may relate to a build information repository, for example build information repository (416) of FIG. 4.

In an example embodiment, at block 512, the user (502) may login to the interface server (504). When performing the login, the user may provide username information, password information, and/or the like. When performing the login, the user may utilize a web browser, a computer program, and/or the like. In an example embodiment, at block 514, build information may be given to the interface server (504). The build information may comprise a makefile, source code, a header, object code, and/or the like. The build information is received by the interface server (504). The build information may be given by uploading a file, sending a message, selecting an item in a menu, providing build environment information, and/or the like. For example, the user may select to use a version of a build environment in a menu and send a source code file and a makefile. In another example, the user may select items in a list comprising build information to be included or excluded from the software build. In yet another example, the user may provide information related to the location of a software component in a computer program, for example a ROM image.

In an example embodiment, at block 516, the interface server (504) may put the received build information in a shared storage, for example shared storage (506). The build information may be put in the shared storage by a message, a file upload, and/or the like. In an example embodiment, at block 518, the interface server (504) may notify the software builder (508) that the received build information is in the shared storage. Although FIG. 5 illustrates the notification going to the software builder (508), it should be understood that the notification may be put to shared storage (506). For example, the notification may be written in a monitored portion of the shared storage (506), which may prompt the software builder (508) to retrieve the notification from shared storage (506). In another example, shared storage (506) may be configured to automatically notify the software builder when a particular storage is modified, which may prompt the software builder (508) to retrieve the notification from shared storage (506). The notification may comprise build information. For example, the notification may comprise build environment information. The notification be a message, information in shared storage, and/or the like.

In an example embodiment, at block 520, the software builder (508) may get received build information from the shared storage (506). The software builder may utilize a message, a file download, and/or the like to get the received build information. In an example embodiment, at block 522, the software builder (508) may get stored build information from the build information repository (510). The software builder may utilize a message, a file download, and/or the like to get the stored build information. The software builder (508) may utilize the received build information to determine the stored build information to be retrieved. For example, the received build information may comprise version information of a software component in the stored build information to be used in the software build. In such an example, the software builder (508) may get build information related to the specified version of the software component. In an example embodiment, at block 524, the software builder (508) may combine the received build information and the stored build information. The combining may comprise operations related to correlating the received build information to the stored build information. For example, the received build information may be packaged in a compressed file, for example a zip file. In such an example, the combining may comprise unpacking the build information, decompressing the build information, and/or the like. In an example embodiment, at block 526, the software builder (508) may perform a software build to generate a computer program.

In an example embodiment, at block 528, the software builder (508) puts the computer program to the shared storage (506). The software builder may utilize a message, a file upload, and/or the like to put the computer program in the shared storage (506). It should be understood that there may be no computer program put in shared storage (506) at block 528. For example, an error may have been encountered when performing the software build. In such an example, there may have been no computer program generated by the software build. In an example embodiment, at block 530, the software builder (508) may notify the interface server (504) of the completion status of the software build. Although FIG. 5 illustrates the notification going to the interface server (504), it should be understood that the notification may be put to shared storage (506). For example, the notification may be written in a monitored portion of the shared storage (506), which may prompt the interface server (508) to retrieve the notification from shared storage (506). In another example, shared storage (506) may be configured to automatically notify the software builder when a particular storage is modified, which may prompt the interface server (508) to retrieve the notification from shared storage (506). The notification may comprise error information, build time information, percentage of completion information, and/or the like. For example, the notification may comprise information relating to a link error that may have been encountered in the build process. The notification may comprise utilization of a message, a putting of information in shared storage, and/or the like.

In an example embodiment, at block 532, the interface server (504) may get the computer program from shared storage (506). The interface server (504) may utilize a message, a file upload, and/or the like to get the computer program. It should be understood that there may be no computer program to get from shared storage (506) at block 532. For example, an error may have been encountered when performing the software build. In such an example, there may have been no computer program generated by the software build. In an example embodiment, at block 534, the interface server (504) may notify the user (502) of the completion of the software build. The notification may comprise a message, a web page pop-up, a file upload, and/or the like. For example, the notification may be an email message sent to the user.

In an example embodiment, at block 536, the user (502) may login to the interface server (504). When performing the login, the user may provide username information, password information, and/or the like. When performing the login, the user may utilize a web browser, a computer program, and/or the like. In an example embodiment, at block 538, the user (502) may get a computer program from the interface server (504). The getting may comprise the interface server (504) sending the computer program. The user may utilize a message, a file download, and/or the like to get the computer program. In some cases, the user may not perform the login (536) and getting of the computer program (538). For example, if the computer program is included in the notification of block 534, the user may avoid blocks 536 and 538. In another example, if an error is encountered in the build process of block 524, the user may avoid blocks 536 and 538.

In some cases, there may be more than one software builder. In such cases it may be desirable to control the amount of work that is being sent to each software builder. For example, one software builder may be performing a software build, while another software builder has just completed a software build. In such an example, it may be desirable to send a pending software build job to the software builder which has just completed a software build. In such situations, it may be desirable to have a scheduler controlling the work that is sent to software builders.

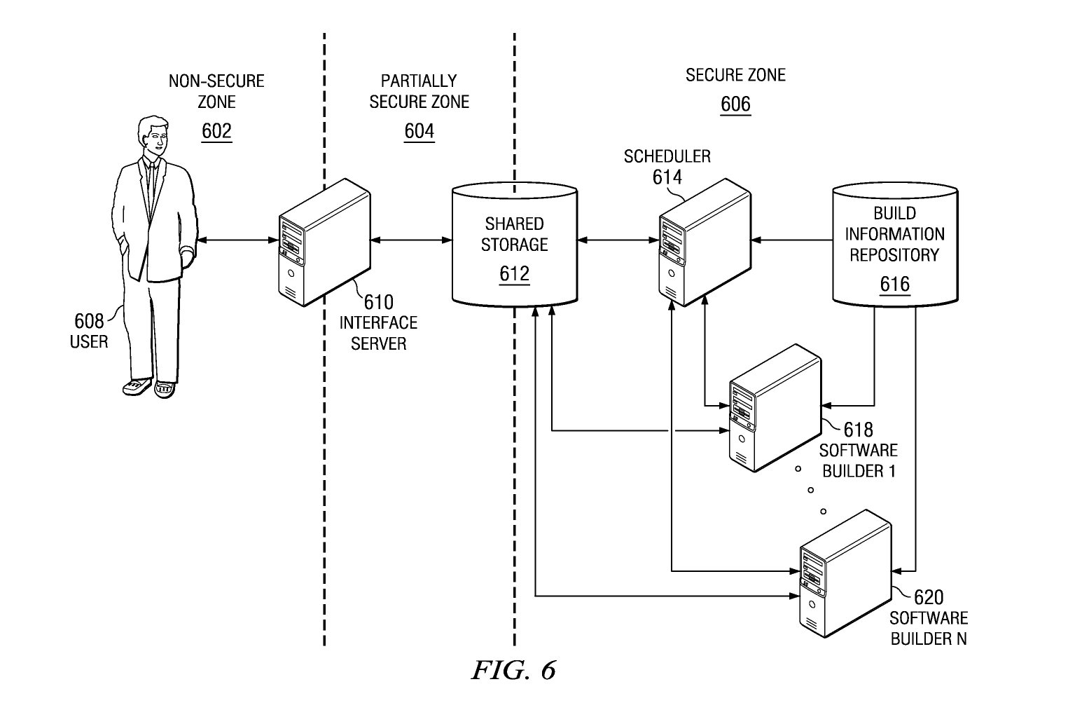

FIG. 6 is a diagram of yet another example embodiment of a software building apparatus. It should be understood, however, that the software building apparatus of FIG. 6 as illustrated and hereinafter described is merely illustrative of a software building apparatus, and therefore, should not be taken to limit the scope of the present invention.

In an example embodiment, there may be zones relating to a level of security, for example a non-secure zone (602), a partially secure zone (604), a secure zone (606), and/or the like. In an example embodiment, a non-secure zone (602) is a zone where communications may be intercepted, may pass through uncontrolled devices, and/or the like. For example, the internet may be a non-secure zone. In an example embodiment, a partially secure zone (604) is a zone where communication may be difficult to intercept, but where data is accessed by a device that is connected to a non-secure zone. In an example embodiment, a secure zone (606) is a zone where communication may be difficult to intercept and where a device connected to a non-secure zone may not directly access data.

In an example embodiment, a user (608) may operate in a non-secure zone. It should be understood that the user (408) may be a human, a script, a computer program, and/or the like. The user (408) may utilize an interface server (610) in varying ways. For example, the user (608) may utilize a communicating apparatus, for example communicating apparatus (700) of FIG. 7, which communicates with the interface server (610) using an internet connection. In another example, the user (608) may utilize a kiosk which is connected to an interface server (610). The interface server (610) may provide the user with various operations. For example, the interface server (610) may allow a user to login, choose software build characteristics, send software build information, initiate a software build, receive notification of a completed software build, download a computer program from a completed software build, and/or the like. In an example embodiment, the interface server (610) may utilize a user validation method, such as a user id and/or password, before allowing a user to access at least one of the operations provided by the interface server (610). The interface server (610) may comprise a communicating apparatus, for example communicating apparatus (700) of FIG. 7. In an example embodiment, an interface server (610) may utilize a protection mechanism, such as a firewall, to restrict access. It should be understood that there may be more than one interface server (610). For example, it may be desirable to provide more than one interface server (610) for balancing load, separately managing groups of users, and/or the like.

In an example embodiment, the interface server (610) may be coupled to a shared storage (612). The shared storage (612) may comprise a communicating apparatus, for example communicating apparatus (700) of FIG. 7. The shared storage may be used to store received build information, for example build information 2 (206) of FIG. 2, a computer program generated by a completed software build, a communication message between the interface server (610) and the software builder (614), and/or the like. The shared storage (612) may be remote to or may be local to the interface server (610). The shared storage (612) may be remote to or may be local to the software builder (614).

In an example embodiment, a software builder, for example software builder 1 (618), performs a software build. Software builder 1 (618) may comprise a communicating apparatus, for example communicating apparatus (700) of FIG. 7. Software builder 1 (618) may utilize received build information, for example build information stored in the shared storage (612), and stored build information, for example build information stored in the build information repository (616). Software builder 1 (618) may combine the received build information and the stored build information. The combining may comprise operations related to correlating the received build information to the stored build information. For example, the received build information may be packaged in a compressed file, for example a zip file. In such an example, the combining may comprise unpacking the build information, decompressing the build information, and/or the like. Software builder 1 (618) may perform a software build using the combined build information to generate a computer program. It should be understood that software builder N (620) functions similarly to software builder 1 (618).

In an example embodiment, the software scheduler (614) may evaluate work load information related to software builders and assign software builders to perform individual software builds. Software scheduler (614) may comprise a communicating apparatus, for example communicating apparatus (700) of FIG. 7. For example a software scheduler may evaluate the work load of the software builders and determine that the next software build is performed on software builder N (620).

FIG. 7 is a diagram of an example embodiment of a communicating apparatus 700. It should be understood, however, that the communicating apparatus of FIG. 7 as illustrated and hereinafter described is merely illustrative of a communicating apparatus, and therefore, should not be taken to limit the scope of the present invention.

In an example embodiment, the communicating apparatus (700) may comprise a controller (702), a receiver (704), and a transmitter (706). The controller may comprise a processor, a memory, a user interface, and/or the like. The controller (702) may perform various operations. For example, the controller may perform operations on information received by the receiver (704). In another example, the controller may perform operations on information prior to transmitting the information by the transmitter (706). In yet another example, the controller (702) may combine software build information. In still another example, the controller (702) may perform a software build.

The receiver (704) may comprise a device configured to receive information. The transmitter (706) may comprise a device configured to transmit information. In some cases, the transmitter and receiver may be parts of the same device. For example, the transmitter and receiver may be parts of an Ethernet device, parts of a modem, parts of a wireless communication device, and/or the like. The receiver (704) and transmitter (706) may utilize a wireless and/or a wire-line method for communicating information. For example, the transmitter (706) and/or the receiver (704) may perform a communication using Ethernet communication. In another example, the transmitter (706) and/or the receiver may perform a communication using an 802.11(g) communication.

Without in any way limiting the scope, interpretation, or application of the claims appearing below, it is possible that a technical effect of one or more of the example embodiments disclosed herein may be performing a software build without revealing confidential software build information. Another possible technical effect of one or more of the example embodiments disclosed herein may be providing a service to customize software.

Embodiments of the present invention may be implemented in software, hardware, application logic or a combination of software, hardware and application logic. The software, application logic and/or hardware may reside on a part of a computer, and/or more than one computer. If desired, part of the software, application logic and/or hardware may reside on one computer, part of the software, application logic and/or hardware may reside on the same computer, and part of the software, application logic and/or hardware may reside on another computer. For example, the interface server may reside on one computer, while the shared storage, the build information repository, and the software builder may reside on another computer. In another example, the interface server, the shared storage, the build information repository, and the software builder may reside on different computers. In yet another example, the interface server, the build information repository, and the software builder may reside on the same computer without a shared storage. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. An apparatus, comprising:
at least one receiver configured to receive a first software build information; and
at least one transmitter configured to send a computer program, wherein said computer program is based at least in part on said first software build information and a second software build information.

2. The apparatus of claim 1, further comprising a processor configured to perform a software build based at least in part on said first software build information and based at least in part on said second software build information to generate said computer program.

3. The apparatus of claim 1, wherein said at least one receiver is operable over the internet.

4. The apparatus of claim 1, wherein said at least one transmitter is operable over the internet.

5. The apparatus of claim 1, wherein at least part of said second software build information comprises confidential information.

6. The apparatus of claim 1, further comprising memory for storing said second software build information.

7. The apparatus of claim 1, wherein said receiving of said first software build information is performed in a non-secure zone.

8. The apparatus of claim 1, wherein said receiving of said first software build information is performed in a semi-secure zone.

9. The apparatus of claim 1, wherein said second software build information is stored at least in part in a secure zone.

10. A method, comprising:
receiving a first software build information; and
sending a computer program, wherein said computer program is based at least in part on said first software build information and a second software build information.

11. The method of claim 10, further comprising performing a software build based at least in part on said first software build information and at least in part on said second software build information.

12. The method of claim 10, wherein said receiving comprises receiving said first software build information over the internet.

13. The method of claim 10, wherein said sending comprises sending said computer program over the internet.

14. The method of claim 10, wherein said second software build information comprises confidential information.

15. The method of claim 10, further comprising retrieving said second software build information from a memory.

16. The method of claim 7, wherein said sending comprises notifying a user.

17. The method of claim 10, further comprising sending build completion information.

18. The method of claim 10, wherein said sending comprises sending an email.

19. The method of claim 10, wherein said sending comprises performing a file download.

20. The method of claim 10, wherein said sending is performed by an interface server.

21. The method of claim 10, wherein said receiving is performed by an interface server.

22. The method of claim 10, wherein said receiving of said first software build information is performed in a non-secure zone.

23. The method of claim 10, wherein said receiving of said first software build information is performed in a semi-secure zone.

24. The method of claim 10, wherein said second software build information is stored at least in part in a secure zone.

25. A computer program product comprising a computer-readable medium bearing computer program code embodied therein for use with a computer, the computer program code comprising:
code for receiving a first software build information; and
code for sending a computer program, wherein said computer program is based at least in part on said first software build information and a second software build information.

26. The computer program product of claim 25, further comprising code for performing a software build based at least in part on said first software build information and based at least part on said second software build information.

27. The computer program product of claim 25, wherein said receiving comprises receiving said first software build information over the internet.

28. The computer program product of claim 25, wherein said sending comprises sending said second build information over the internet.

29. The computer program product of claim 25, wherein said second software build information comprises confidential information.

30. The computer program product of claim 25, further comprising code for retrieving said second software build information from a memory.

31. The computer program product of claim 25, wherein said sending comprises notifying a user.

32. The computer program product of claim 25, further comprising code for sending build completion information.
